(19) United States
(12) Patent Application Publication
(10) Pub. No.: US 2026/0183873 A1
(43) Pub. Date: Jul. 2, 2026

(54) SUBSTRATE MANUFACTURING METHOD AND LASER PROCESSING METHOD

(71) Applicant: DISCO CORPORATION, Tokyo (JP)

(72) Inventor: Ryosuke SAKURAI, Tokyo (JP)

(21) Appl. No.: 19/411,691

(22) Filed: Dec. 8, 2025

(30) Foreign Application Priority Data
Dec. 26, 2024 (JP) 2024-229884

(51) Int. Cl. B23K 26/53; B23K 101/40

(52) U.S. Cl. CPC B23K 26/53; B23K 2101/40

(57) ABSTRACT

A substrate manufacturing method includes moving a focused spot and the workpiece relative to each other, while irradiating the workpiece with a laser beam having a wavelength transmissible through a material of the workpiece in such a manner that the focused spot is positioned inside the workpiece, thereby forming a peel-off layer including modified portions in the workpiece, and peeling off part of the workpiece which is to be the substrate from the rest thereof, with the peel-off layer as a separation initiating point, in which an irradiation condition of the laser beam is set such that, when the workpiece is viewed in plan, the peel-off layer having a proportion of the modified portions that is a proportion of an area of the modified portions to an area of the peel-off layer is over 0% and equal to or less than 24% is formed.

### BACKGROUND OF THE INVENTION

### Field of the Invention

The present invention relates to a substrate manufacturing method which manufactures a substrate having a thickness smaller than a thickness of a workpiece from the workpiece and to a laser processing method which forms a peel-off layer including modified portions and cracks extending from the modified portions inside the workpiece.

### Description of the Related Art

Dies of semiconductor devices are manufactured, in general, using a substrate having a single crystal made of silicon (Si), silicon carbide (SiC) or the like as a material. After a peel-off layer including modified portions and cracks extending from the modified portions inside a workpiece such as an ingot is formed, for example, this substrate is manufactured by separating the workpiece with the peel-off layer as a separation initiating point. Specifically, in this case, part of the workpiece is peeled off from the rest thereof with the peel-off layer as the separation initiating point, resulting in formation of the relevant substrate.

Such a peel-off layer is formed using a laser beam of a wavelength transmissible through the material of the workpiece (see, for example, Japanese Patent Laid-Open No. 2022-25566). Specifically, such a peel-off layer is formed by moving a focused spot and a workpiece relative to each other while applying the laser beam to the workpiece such that the focused spot is positioned inside the workpiece.

### SUMMARY OF THE INVENTION

When the workpiece is separated with the peel-off layer as a separation initiation point, that is, when the part of the workpiece is peeled off from the rest of the workpiece, an external force is applied to the workpiece in such a manner as to further extend the cracks formed in the peel-off layer. However, in a case in which application of a strong external force is required upon this peeling-off, cracks may extend in an unintended direction due to the application of this external force. In this case, breakage of the workpiece may be caused to such a degree that a substrate to be manufactured cannot be used for manufacture of the semiconductor device.

In view of this circumstance, it is an object of the present invention to provide a substrate manufacturing method and a laser processing method which are capable of preventing breakage of a substrate when part of a workpiece serving as a substrate is peeled off from the rest of the workpiece with a peel-off layer as a separation initiating point.

The present inventor found that, in a case in which a peel-off layer having a proportion of modified portions which is a proportion of an area of the modified portions to an area of the peel-off layer when the workpiece is viewed in plan is over 0% and 24% or less is formed in the workpiece, it is possible to prevent breakage of a substrate occurring when part of the workpiece is peeled off from the rest thereof with the peel-off layer as a separation initiating point, and completes the present invention.

Specifically, in accordance with an aspect of the present invention, there is provided a substrate manufacturing method of manufacturing, from a workpiece, a substrate having a thickness smaller than that of the workpiece, including moving a focused spot and the workpiece relative to each other, while irradiating the workpiece with a laser beam having a wavelength transmissible through a material of the workpiece in such a manner that the focused spot is positioned inside the workpiece, thereby forming a peel-off layer including modified portions and cracks extending from the modified portions in the workpiece, and peeling off part of the workpiece which is to be the substrate from the rest thereof, with the peel-off layer as a separation initiating point, in which an irradiation condition of the laser beam is set such that, when the workpiece is viewed in plan, the peel-off layer having a proportion of the modified portions that is a proportion of an area of the modified portions to an area of the peel-off layer is over 0% and equal to or less than 24% is formed.

Note that the irradiation condition is preferably set such that the peel-off layer is formed such that the proportion of the modified portions is equal to or less than 16%. In addition, the peeling-off of the part of the workpiece from the rest thereof is preferably performed after, when the workpiece is viewed in plan, a proportion of the peel-off layer that is a proportion of the area of the peel-off layer to the area of the workpiece is 98% or more. Moreover, the material of the workpiece is preferably a single crystal made of silicon.

In accordance with another aspect of the present invention, there is provided a laser processing method of using a laser beam having a wavelength transmissible through a material of a workpiece and forming a peel-off layer including modified portions and cracks extending from the modified portions, in the workpiece. The method includes moving a focused spot and the workpiece relative to each other, while irradiating the workpiece with the laser beam in such a manner that the focused spot is positioned inside the workpiece, thereby forming the peel-off layer having a proportion of the modified portions that is a proportion of an area of the modified portions to an area of the peel-off layer is over 0% and equal to or less than 24% when the workpiece is viewed in plan.

According to the present invention, the peel-off layer having a proportion of the modified portions that is a proportion of an area of the modified portions to an area of the peel-off layer is over 0% and equal to or less than 24% when the workpiece is viewed in plan is formed. Accordingly, the breakage of the substrate occurring when the part of the workpiece is peeled off from the rest thereof with the peel-off layer as a separation initiating point can be prevented.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a perspective view schematically illustrating an ingot to be used for manufacturing of a substrate;

FIG. 2 is a top plan view schematically illustrating the ingot illustrated in FIG. 1;

FIG. 3 is a flowchart schematically illustrating an example of a procedure of a substrate manufacturing method of manufacturing a substrate having a thickness smaller than a thickness of the ingot with the ingot as a workpiece illustrated in FIG. 1;

FIG. 4 is a top plan view schematically illustrating an example of a plurality of regions in which peel-off layers are sequentially formed in a peel-off layer forming step illustrated in FIG. 3;

FIG. 5 is a view schematically illustrating an example of a laser processing apparatus used in the peel-off layer forming step illustrated in FIG. 3;

FIG. 6 is a top plan view schematically illustrating the ingot which is held on a holding table of the laser processing apparatus illustrated in FIG. 5 and an orientation of which is adjusted;

FIG. 7 is a flowchart schematically illustrating an example of a procedure when the peel-off layers are sequentially formed in the plurality of regions illustrated in FIG. 4;

FIG. 8A is a top plan view schematically illustrating the manner in which a laser beam irradiating step illustrated in FIG. 7 is performed;

FIG. 8B is a side elevational view, partly in cross section, schematically illustrating the manner in which the laser beam irradiating step illustrated in FIG. 7 is performed;

FIG. 9 is a cross sectional view schematically illustrating the manner in which the peel-off layer is formed in the ingot in the laser beam irradiating step illustrated in FIG. 7;

FIG. 10A is a side elevational view, partly in cross section, schematically illustrating an example of a peeling step illustrated in FIG. 3;

FIG. 10B is a side elevational view, partly in cross section, schematically illustrating the example of the peeling step illustrated in FIG. 3;

FIG. 11A is a side elevational view, partly in cross section, schematically illustrating another example of the peeling step illustrated in FIG. 3;

FIG. 11B is a side elevational view, partly in cross section, schematically illustrating the other example of the peeling step illustrated in FIG. 3;

FIG. 12A is a side elevational view, partly in cross section, schematically illustrating still another example of the peeling step illustrated in FIG. 3; and

FIG. 12B is a side elevational view, partly in cross section, schematically illustrating the still other example of the peeling step illustrated in FIG. 3.

### DETAILED DESCRIPTION OF THE PREFERRED EMBODIMENT

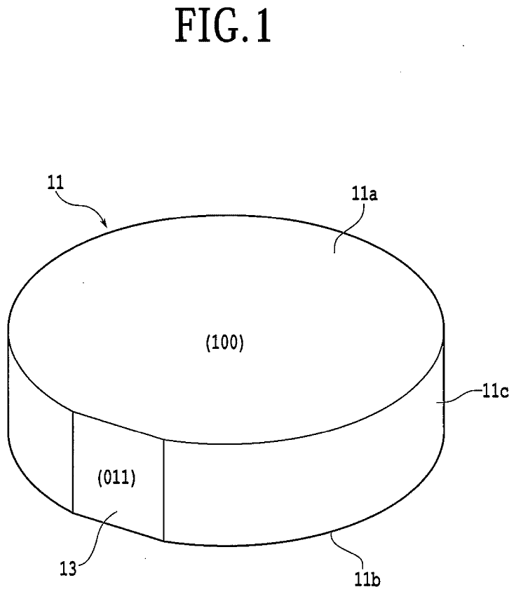

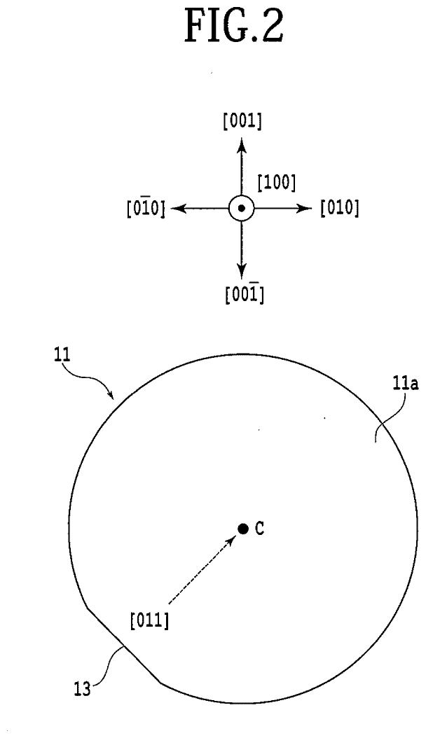

A preferred embodiment of the present invention will be described in detail below with reference to the accompanying drawings. FIG. 1 is a perspective view schematically illustrating an ingot (ingot 11) to be used for manufacturing of a substrate, and FIG. 2 is a top plan view schematically illustrating the ingot 11 illustrated in FIG. 1. Note that, in FIG. 1, some of the crystal planes of the material of the ingot 11 exposed in planes included in the ingot 11 are also illustrated. In addition, in FIG. 2, crystal orientations of the material of the ingot 11 are also illustrated.

The ingot 11 includes a single crystal made of silicon as the material. Also, in the ingot 11, a particular crystal plane (here, defined as a crystal plane (100) for convenience) included in the crystal planes {100} is exposed in each of a front surface 11a and a back surface 11b. Specifically, in this ingot 11, a perpendicular line (crystal axis) of each of the front surface 11a and the back surface 11b is along a crystal orientation [100].

Note that the ingot 11 is manufactured such that the crystal plane (100) is exposed in each of the front surface 11a and the back surface 11b. However, each of the front surface 11a and the back surface 11b may be a surface slightly inclined from the crystal plane (100) due to a processing error in the manufacturing, for example. More specifically, each of the front surface 11a and the back surface 11b of the ingot 11 may be a surface that forms an acute angle of equal to or smaller than 1° with the crystal plane (100). Specifically, a crystal axis of the ingot 11 may be along a direction that forms an acute angle of equal to or smaller than 1° with the crystal orientation [100].

In addition, an orientation flat 13 is formed in a side surface 11c of the ingot 11, and a center C of the ingot 11 is located in a particular crystal orientation included in the crystal orientations <110> (here, defined as a crystal orientation [011] for convenience) as viewed from the orientation flat 13. Specifically, the crystal plane (011) is exposed in the orientation flat 13.

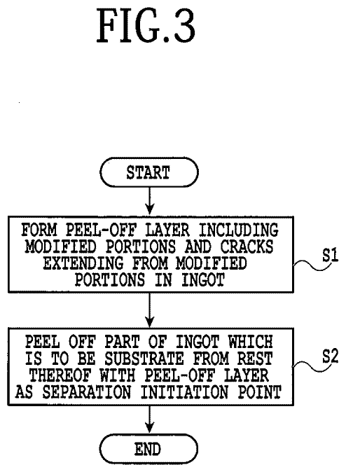

FIG. 3 is a flowchart schematically illustrating an example of a procedure of a substrate manufacturing method of manufacturing a substrate having a thickness smaller than a thickness of the ingot 11 with the ingot 11 as a workpiece. In this method, first, a peel-off layer including modified portions and cracks extending from the modified portions is formed in the ingot 11 (peel-off layer forming step S1).

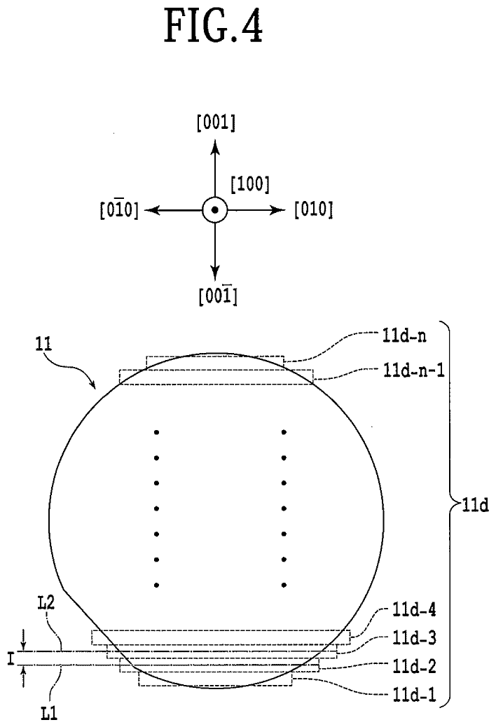

In the peel-off layer forming step S1, peel-off layers are sequentially formed in a plurality of regions included in the ingot 11 and each linearly extending. FIG. 4 is a top plan view schematically illustrating an example of a plurality of regions in which peel-off layers are sequentially formed in the peel-off layer forming step S1. Note that, in FIG. 4, the crystal orientations of the material of the ingot 11 is also illustrated.

As illustrated in FIG. 4, each of a plurality of regions 11d (for example, each of n regions 11d_1, 11d_2, 11d_3, 11d_4 to 11d_n-1, and 11d_n) extends along the crystal orientation [010] and is equal in width (length along the crystal orientation [001]). In addition, an interval I between centers of the plurality of regions 11d in the crystal orientation [001] is equal to the width of each of the regions 11d, and is, for example, 50 μm or more and 500 μm or less.

Note that the interval I is an interval between a straight line L1 which passes through the center of one of a pair of adjacent regions 11d (for example, the region 11d_2) and extends along the crystal orientation [010] and a straight line L2 which passes through the center of the other of the pair of adjacent regions 11d (for example, the region 11d_3) and extends along the crystal orientation [010]. In addition, the width of each of the regions 11d and the interval I are set, for example, in such a manner as to be substantially equal to the width of the peel-off layer (the length in a direction perpendicular to an advancing direction of a processing point in plan view) formed in the peel-off layer forming step S1.

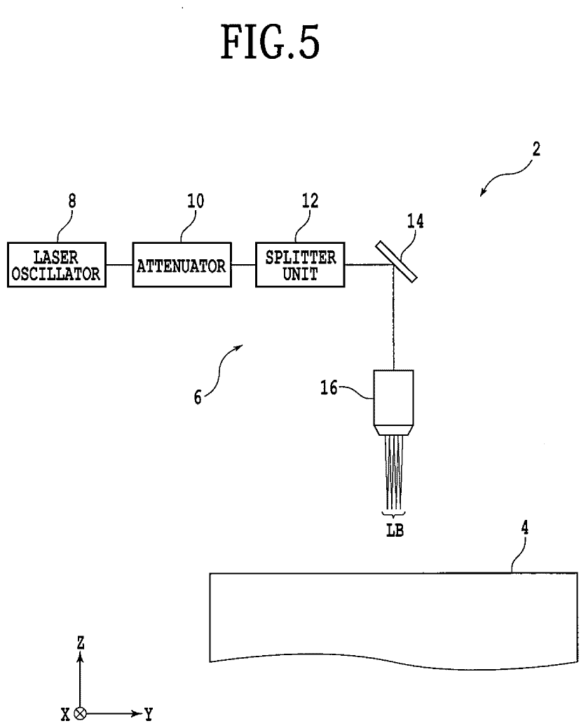

Also, in the peel-off layer forming step S1, with use of the laser processing apparatus, a peel-off layer is formed in each of the plurality of regions 11d. FIG. 5 is a view schematically illustrating an example of a laser processing apparatus (laser processing apparatus 2) used in the peel-off layer forming step S1.

It is to be noted that a direction (X direction) indicated by an arrow X and a direction (Y direction) indicated by an arrow Y in FIG. 5 are directions orthogonal to each other in a horizontal plane and that a direction (Z direction) indicated by an arrow Z is a direction (vertical direction) orthogonal to each of the X direction and the Y direction. FIG. 5 also illustrates some of the components of the laser processing apparatus 2 in functional blocks.

The laser processing apparatus 2 includes a holding table 4 for holding the ingot 11 and a laser beam application unit 6 for applying a laser beam LB to the ingot 11 held on the holding table 4.

The holding table 4 has a circular upper surface (holding surface) parallel to the X direction and the Y direction. In addition, the holding table 4 has a porous plate (not illustrated) in a circular plate shape, and an upper surface thereof is exposed in the holding surface. Also, the porous plate is fluidly communicated with an undepicted suction source such as an ejector, for example, through an undepicted fluid channel, for example, defined in the holding table 4.

When the suction source communicating with the porous plate is actuated, it creates and transmits a suction force through the fluid channel and the porous plate to a space near the holding surface of the holding table 4. Thus, by placing the ingot 11 on the holding surface of the holding table 4 and causing the suction source which is fluidly communicated with the porous plate to actuate, the ingot 11 can be held on the holding surface of the holding table 4.

Also, the holding table 4 is coupled with an unillustrated rotating mechanism. This rotating mechanism includes, for example, a driven pulley which is coupled with the holding table 4, a belt which is wound around the driven pulley, a drive pulley which is coupled with the driven pulley through the belt, and a motor which rotates the drive pulley.

Then, when the rotating mechanism (specifically, its motor) is actuated, with a straight line extending along the Z direction and passing through the center of the holding table 4 as a rotational axis, the holding table 4 is rotated. Accordingly, when the rotating mechanism is actuated in a state in which the ingot 11 is held on the holding surface of the holding table 4, the orientation of the ingot 11 (more specifically, an angle formed between a particular crystal orientation of the material of the ingot 11 and the X direction or the Y direction) can be adjusted.

The laser beam application unit 6 includes a laser oscillator 8. The laser oscillator 8 has, for example, as a laser medium, neodymium-doped yttrium aluminum garnet (Nd:YAG) or the like. The laser oscillator 8 emits a pulsed laser beam LB having such a wavelength as to be transmitted through the material of the ingot 11 (a single crystal made of silicon) (for example, 1064 nm or 1342 nm) (for example, a frequency of 10 kHz or more and 200 kHz or less).

The laser beam LB is supplied to a splitter unit 12 after its output power is adjusted in an attenuator 10 to be, for example, 3 W or more and 10 W or less. The splitter unit 12 has a spatial light modulator and/or a diffractive optical element (DOE), and the like, including, for example, a liquid crystal phase control element called Liquid Crystal on Silicon (LCoS).

The splitter unit 12 splits the laser beam LB into the same number as a plurality of focused spots in such a manner that the laser beam LB emitted from the head 16 to be described later forms the plurality of focused spots (for example, 3 or more and 16 or less; in FIG. 5 or the like for convenience, 4) arranged along the Y direction. In addition, the laser beams LB thus split are guided into the head 16 through an optical system including a mirror 14 and the like housed in a housing (not illustrated).

The head 16 is provided at a position higher than the holding table 4. In addition, the head 16 has a lens (not illustrated) and the like, for focusing the split laser beams LB. Then, the laser beam LB which has been focused with the lens is emitted from the head 16 directly downward.

Moreover, the head 16 is provided at a distal end of the housing (not illustrated) which houses the optical system for guiding the laser beam LB to the head 16, and at a proximal end of the housing, an X direction moving mechanism (not illustrated), a Y direction moving mechanism (not illustrated), and a Z direction moving mechanism (not illustrated) are coupled with the housing. Each of the moving mechanism includes a ball screw operatively coupled with the housing and an electric motor for rotating a screw shaft of the ball screw about its longitudinal central axis.

Then, when at least one of these moving mechanisms (specifically, motors of them) is actuated, the head 16 and the housing are moved along the X direction, the Y direction and/or the Z direction. Accordingly, these moving mechanisms are actuated, so that the position (coordinate) of the focused spot of the laser beam LB emitted from the head 16 to the holding surface side of the holding table 4 and focused in the X direction, the Y direction, and/or the Z direction can be adjusted.

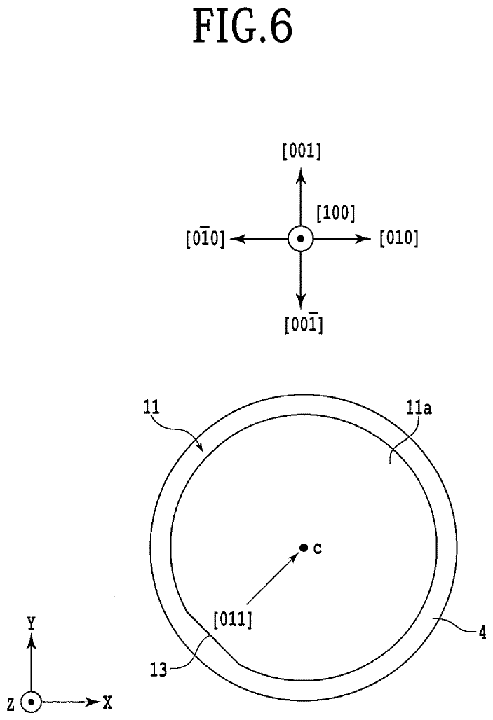

When the laser processing apparatus 2 performs the peel-off layer forming step S1, first, the ingot 11 is loaded onto the holding table 4 such that the front surface 11a thereof faces upward, and the back surface 11b of the ingot 11 is held on the holding surface of the holding table 4. Next, as needed, the orientation of the ingot 11 is adjusted. FIG. 6 is a top plan view schematically illustrating the ingot 11 which is held on the holding surface of the holding table 4 and an orientation of which is adjusted. Note that, in FIG. 6, the crystal orientations of the material of the ingot 11 is also illustrated.

The orientation of the ingot 11 is adjusted, for example, such that an angle formed between a direction extending from the orientation flat 13 to the center C of the ingot 11 (crystal orientation [011]) and each of the X direction and the Y direction is 45°. Specifically, the orientation of the ingot 11 is adjusted such that the crystal orientation [010] is parallel to the X direction and the crystal orientation [001] is parallel to the Y direction, for example.

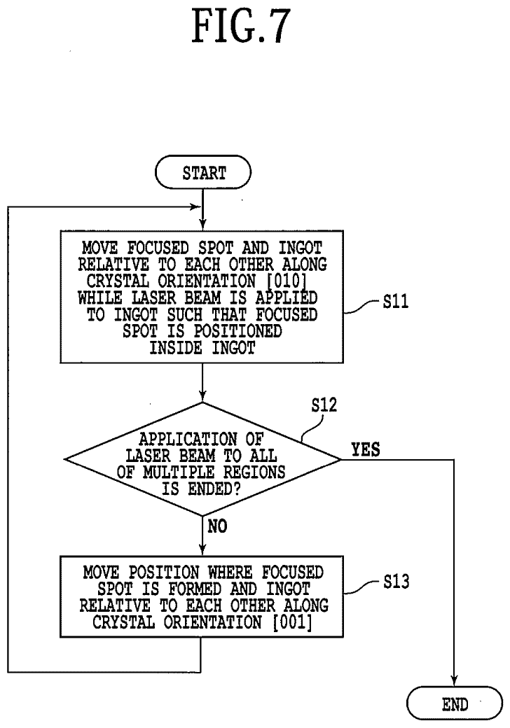

In this manner, the orientation of the ingot 11 held on the holding surface of the holding table 4 is adjusted, and the peel-off layers are sequentially formed in the plurality of regions 11d. FIG. 7 is a flowchart schematically illustrating an example of a procedure when the peel-off layers are sequentially formed in the plurality of regions 11d. In this procedure, first, the focused spot and the ingot 11 are moved relative to each other along the crystal orientation [010] while the laser beam LB is applied to the ingot 11 such that the focused spot is positioned inside the ingot 11 (laser beam irradiating step S11).

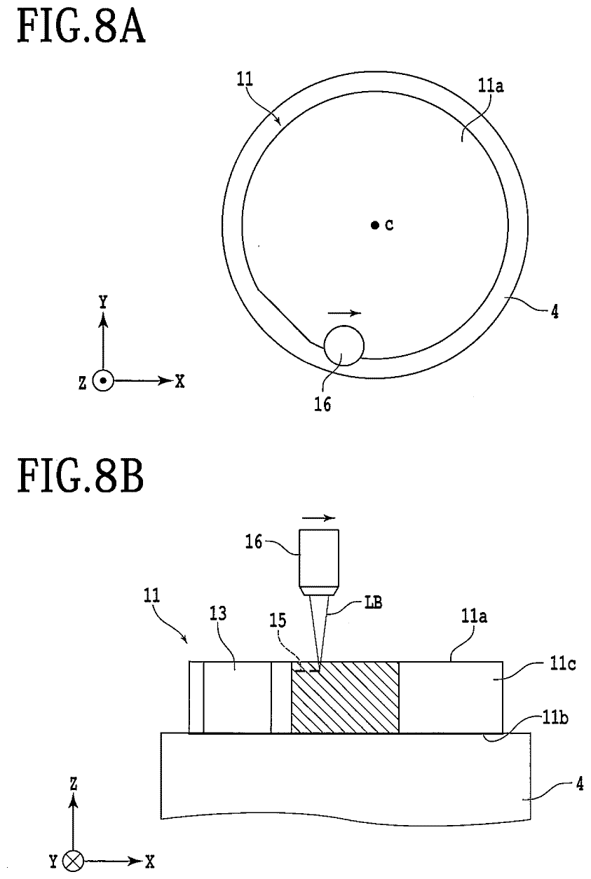

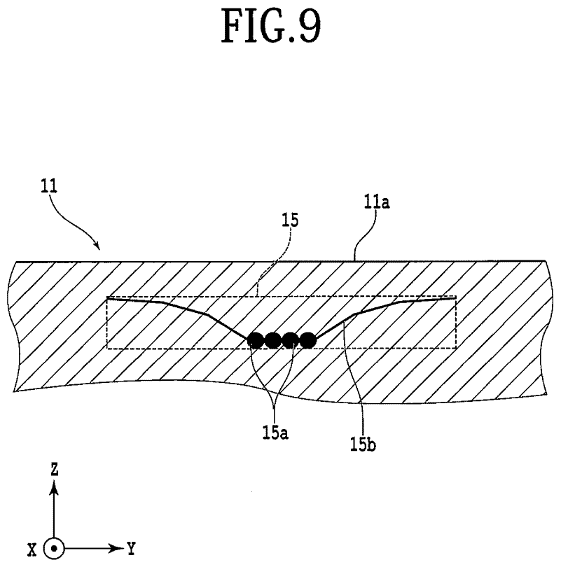

FIG. 8A is a top plan view schematically illustrating the manner in which the laser beam irradiating step S11 is performed, and FIG. 8B is a side elevational view, partly in cross section, schematically illustrating the manner in which the laser beam irradiating step S11 is performed. FIG. 9 is a cross sectional view schematically illustrating the manner in which the peel-off layer is formed in the ingot in the laser beam irradiating step S11. In the laser beam irradiating step S11, for example, the peel-off layer is first formed in the region 11d_1 positioned at one end in the Y direction (crystal orientation [001]) in the plurality of regions 11d.

More specifically, first, in plan view, the head 16 of the laser beam application unit 6 is positioned such that the region 11d_1 (more specifically, as viewed from the center of the head 16 in plan view, the center of the region 11d_1 in the Y direction (crystal orientation [001])) is positioned in the X direction, when viewed from the head 16. Then, the head 16 is moved up and down such that a plurality of focused spots formed by focusing the split laser beams LB are positioned from the front surface 11a of the ingot 11 to a depth of 100 μm or more and 1500 μm or less.

Then, the head 16 is moved at a speed of, for example, 100 mm/s or higher and 1500 mm/s or lower (see FIGS. 8A and 8B) while emitting the laser beam LB from the head 16 toward the holding table 4, in such a manner as to pass from one end of the X direction (crystal orientation [010]) of the ingot 11 to the other end. In this manner, when the head 16 is moved while applying the laser beam LB from the head 16, in a state in which the plurality of focused spots are positioned inside the ingot 11, the plurality of focused spots and the ingot 11 are moved relative to each other along the X direction (crystal orientation [010]). More specifically, with the X direction (crystal orientation [010]) as a scan direction of the laser beam LB, the laser beam LB is applied to the ingot 11.

At this time, a pulse energy of each of the split laser beams LB, specifically, an energy obtained by dividing the output power of the laser beam LB adjusted in the attenuator 10 by the frequency and the number of beam splits, is set to, for example, 0.001 mJ or more and 0.1 mJ or less, typically, 0.01 mJ. In addition, the irradiation pitch of each of the split laser beams LB, specifically, the distance obtained by dividing the moving speed (processing feed speed) of the head 16 which emits the laser beam LB by the frequency of the laser beam LB is set, for example, to 1 μm or more and 10 μm or less, typically, 6.75 μm.

Accordingly, in the region 11d_1, with the plurality of focused spots each set as a center, a portion (modified portion) 15a serving as amorphous silicon attributable to disordering of the crystal structure of single crystal made of silicon is formed. In addition, when the modified portion 15a is formed in the region 11d_1, the volume of the region 11d_1 expands, and an internal pressure is generated. Thus, the cracks 15b are formed due to the internal pressure in such a manner as to cleave the peripheral portions in the vicinity of the modified portion 15a. As a result, a peel-off layer 15 including a plurality of modified portions 15a and the cracks 15b extending from each of the plurality of modified portions 15a is formed in the region 11d_1.

Here, the irradiation condition of the laser beam LB in the laser beam irradiating step S11 is set such that, when the ingot 11 is viewed in plan, the peel-off layer 15 having a proportion of modified portions which is the proportion of the area of the modified portions 15a to the area of the peel-off layer 15 is over 0% and 24% or less, preferably 16% or less, is formed. Hence, it is possible to prevent, when part of the ingot 11 is peeled off from the rest thereof with the peel-off layer 15 as the separation initiating point, breakage of the relevant part of the ingot 11.

Note that the proportion of the modified portions is calculated with reference to an image formed by capturing the ingot 11 from a position immediately above the ingot 11 in a state in which the ingot 11 is irradiated obliquely from above, for example, with a light ray having a wavelength transmissible through the material of the ingot 11 (for example, infrared rays (IR)). More specifically, in a region of the ingot 11 where no peel-off layer 15 is formed, the corresponding light ray is not reflected, while the corresponding light ray is reflected in the region where the peel-off layer 15 is formed.

Moreover, in the region of the peel-off layer 15 where the cracks 15b are formed, a space where the internal pressure is equal to or smaller than the atmospheric pressure is present, and the corresponding light ray is likely to be reflected in the boundary of the relevant space. Owing to this, in the peel-off layer 15, the corresponding light ray is more likely to be reflected in the region where the cracks 15b are formed than in the region where the modified portions 15a are formed. Hence, in the ingot 11 indicated in this image, three regions having different brightnesses are included.

More specifically, in the ingot 11 indicated in this image, the region where the peel-off layer 15 is formed is brighter than the region where no peel-off layer 15 is formed, and in the peel-off layer 15, the region where the cracks 15b are formed is brighter than the other regions (specifically, the region where the modified portions 15a are formed).

Moreover, with respect to this image, as needed, in order to demarcate the three regions clearly, trinarization may be performed. Alternatively, with respect to the peel-off layer 15 indicated in this image, as needed, in order to clearly demarcate the region where the cracks 15b are formed and the region where the modified portions 15a are formed, binarization may be performed.

Then, the proportion of the modified portions is calculated by dividing the area of the region of the peel-off layer 15 indicated in the image where the modified portions 15a are formed by the area of the peel-off layer 15 (specifically, a sum of the area of the region in which the modified portions 15a are formed and the area of the region where the cracks 15b are formed).

In addition, this irradiation condition is set, for example, such that the width of the peel-off layer 15 in plan view (here, a distance between one end and the other end of the peel-off layer 15 in the Y direction (crystal orientation [001])) is substantially equal to the width of each of the regions 11d. Note that this irradiation condition includes the output power of the laser beam LB, the frequency, and the number of splits as well as the moving speed of the head 16 which emits the laser beam LB, and the like.

Also, in a condition in which the laser beam LB has not been applied to all of the plurality of regions 11d (step S12: NO), the position at which the focused spot is formed and the ingot 11 are moved relative to each other along the Y direction (crystal orientation [001]) (index feeding step S13).

In the index feeding step S13, the head 16 is moved along the Y direction (crystal orientation [001]) by the distance corresponding to the interval I described above (an index amount). In this manner, as viewed from the region 11d_2, the head 16 (more specifically, the center of the head 16 in plan view as viewed from the straight line L1) (crystal orientation [010]) is positioned in the X direction.

Next, the laser beam irradiating step S11 is performed again. This laser beam irradiating step S11 is performed as described above, except that the scan direction of the laser beam LB is a direction opposite to the X direction (crystal orientation [0-10]). Thus, its detailed description is omitted.

Moreover, until the peel-off layers 15 are formed in all of the plurality of regions 11d included in the ingot 11, the index feeding step S13 and the laser beam irradiating step S11 are alternately performed. Then, when the peel-off layers 15 are formed in all of the plurality of regions 11d (simply described, the entire region of the ingot 11) (step S12: YES), the peel-off layer forming step S1 is ended.

Note that, in the peel-off layer forming step S1, no peel-off layer 15 may be formed in the entire region of the ingot 11. However, from the perspective of preventing breakage of the part of the ingot 11 when the part of the ingot 11 is peeled off from the rest thereof with the peel-off layer 15 as the separation initiating point, in the peel-off layer forming step S1, the proportion of the peel-off layer 15 which is the proportion of the area of the peel-off layer 15 to the area of the ingot 11 as viewed in plan is preferably set to be 98% or more.

Note that the proportion of the peel-off layer is calculated with reference to, for example, the image to be used when the proportion of the modified portions described above is calculated or an image obtained by performing binarization on this image in order to demarcate the region where the peel-off layer 15 is formed and the region where no peel-off layer 15 is formed. More specifically, the proportion of the peel-off layer is calculated by dividing the area of the region where the peel-off layer 15 indicated in the image is formed by the area of the ingot 11.

In addition, in the peel-off layer forming step S1, application of the laser beam LB to the ingot 11 may be performed only along one direction (for example, the X direction (crystal orientation [010])). Specifically, in the peel-off layer forming step S1, application of the laser beam LB to the ingot 11 may be repeated, with a direction opposite to the one direction (for example, the direction opposite to the X direction (crystal orientation [0-10])) not set as the scan direction of the laser beam LB, and with the one direction set as the scan direction.

In addition, in the peel-off layer forming step S1, application of the laser beam LB to the ingot 11 may be performed along a direction that is not parallel to the crystal orientation [010]. Specifically, in the peel-off layer forming step S1, in place of the laser beam irradiating step S11 and the index feeding step S13, application of the laser beam LB having, as the scan direction that is not parallel to the crystal orientation [010], to the ingot, and a relative movement between the position at which the focused spot along the direction perpendicular to the scan direction in plan view is formed and the ingot 11 may alternately be repeated.

However, from the perspective of preventing an increase in thickness of the peel-off layer 15 formed in the peel-off layer forming step S1 to enhance the productivity of substrates to be manufactured from the ingot 11, this scan direction is preferably the direction parallel to the crystal orientation [010]. In the following description, this perspective will be described.

The single crystal made of silicon is most likely to be cleaved in a particular crystal plane included in the crystal planes {111}. For example, when the ingot 11 having the crystal plane (100) that is a particular crystal plane included in the crystal planes {100} is exposed in each of the front surface 11a and the back surface 11b is irradiated with the laser beam LB along the crystal orientation [011] that is a particular crystal orientation included in the crystal orientations <110>, and the modified portions 15a are formed in the ingot 11, so that cracks 15b are often generated along the crystal plane (more specifically, the crystal plane indicated in the expression (1) below) that is parallel to the crystal orientation [011] among the particular crystal planes included in the crystal planes {111}.

$$( 1 \overline{1} 1 ) , ( 11 \overline{1} ) \qquad ( 1 )$$

Here, an angle formed between the crystal plane (100) and the particular crystal plane included in the crystal planes {111} is approximately 54.7°. Accordingly, in a case in which the ingot 11 is irradiated with the laser beam LB in this manner, the cracks 15b having more components that extend along the thickness direction than components that extend along the direction parallel to the front surface 11a and the back surface 11b of the ingot 11 are more generated.

In contrast, the crystal orientation [010] is a direction in which an angle relative to the particular crystal orientation (for example, crystal orientation [011]) included in the crystal orientation <110> is large (for example, 45°) Hence, in the method indicated in FIG. 3, cracks extending from the modified portions 15a formed in the ingot 11 due to application of the laser beam LB to the particular crystal plane (for example, the crystal plane indicated in the expression (1) described above) included in the crystal planes {111} are not likely to be generated.

In addition, in the laser beam irradiating step S11, application of the laser beam LB forms more cracks extending from the modified portions 15a formed in the ingot 11 along the crystal plane of the particular crystal planes included in the crystal planes {110} that is parallel to the crystal orientation [010](more specifically, the crystal plane indicated in the expression (2) below).

$$( 101 ) , ( \overline{1} 01 ) \qquad ( 2 )$$

Then, while an angle between the particular crystal plane included in the crystal planes {111} and the crystal plane (100) is approximately 54.7°, an angle between the crystal plane (for example, crystal plane (101)) of the particular crystal planes included in the crystal planes {110} that is parallel to the crystal orientation [010] and the crystal plane (100) is 45°.

Accordingly, in the laser beam irradiating step S11, generation of the cracks 15b having more components that extend along the thickness direction than components that extend along the direction parallel to the front surface 11a and the back surface 11b of the ingot 11 are prevented. Specifically, in the laser beam irradiating step S11, the increase of the peel-off layer 15 formed in the ingot 11 is prevented.

In addition, in the peel-off layer forming step S1, application of the laser beam LB to the ingot 11 may be performed so as to draw a spiral trajectory. Specifically, in the peel-off layer forming step S1, for example, the laser beam LB may be applied to the ingot 11 while the holding table 4 which holds the ingot 11 is rotated, the focused spot of the laser beam LB and the center of the ingot 11 are gradually moved toward or away from each other in plan view.

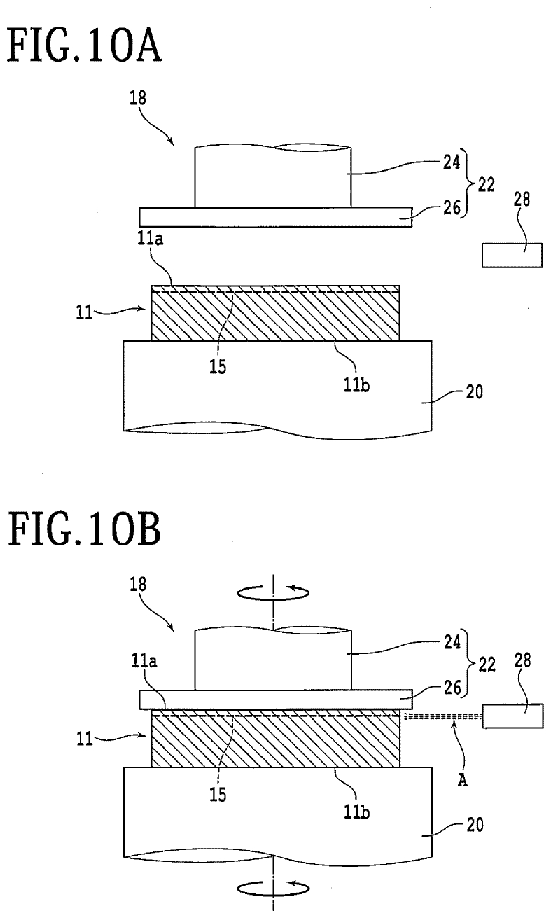

After the peel-off layer forming step S1, the part of the ingot 11 which serves as a substrate is peeled off from the rest thereof with the peel-off layer 15 as the separation initiating point (peeling step S2). FIGS. 10A and 10B schematically illustrate in side elevation, partly in cross section, an example of the peeling step S2. This peeling step S2 is performed, for example, in a peeling apparatus 18 illustrated in FIG. 10A and FIG. 10B.

The peeling apparatus 18 has a holding table 20 for holding the ingot 11 formed with the peel-off layer 15. Specifically, the holding table 20 has a circular upper surface (holding surface) which is perpendicular to the vertical direction and where an undepicted porous plate is exposed upwardly. Moreover, the porous plate is fluidly communicated with an undepicted suction source such as an ejector, for example, through an undepicted fluid channel, for example, defined in the holding table 20.

When the suction source communicated with the porous plate is actuated, it creates and transmits a suction force through the fluid channel and the porous plate to a space near the holding surface of the holding table 20. Accordingly, after the ingot 11 is placed on the holding surface of the holding table 20, the suction source communicating with the porous plate is actuated, thereby making it possible to hold the ingot 11 on the holding surface of the holding table 20.

Also, the holding table 20 is coupled with an unillustrated rotating mechanism. This rotating mechanism includes, for example, a driven pulley which is coupled with the holding table 20, a belt which is wound around the driven pulley, a drive pulley which is coupled with the driven pulley through the belt, and a motor which rotates the drive pulley.

When the rotating mechanism (specifically, its motor) is actuated, it rotates the holding table 20 about its central axis, represented by a straight line, extending vertically through the center of the holding table 20. Accordingly, in a state in which the ingot 11 is held on the holding surface of the holding table 20, the rotating mechanism is actuated, so that the orientation of the ingot 11 can be adjusted.

Provided above the holding table 20 is a holding unit 22. This holding unit 22 has a cylindrical support member 24. In addition, a lower end of the support member 24 is fixed to a center of an upper portion of a holding plate 26 in a circular-plate shape. This holding plate 26 has a circular-shaped lower surface (holding surface) perpendicular to the vertical direction, and this holding surface has a plurality of suction ports formed therein.

In addition, the support member 24 is coupled with a lifting/lowering mechanism, not depicted. This lifting/lowering mechanism includes a ball screw a nut of which is coupled with the support member 24, and a motor for rotating a screw axis of the ball screw. Then, when the lifting/lowering mechanism (more specifically, its motor) is actuated, the support member 24 moves up and down.

Hence, by causing the lifting/lowering mechanism to actuate in such a manner as to lift the holding plate 26 prior to loading of the ingot 11 into the holding table 20 or unloading therefrom, it is possible to sufficiently move the holding plate 26 away from the holding table 20 in such a manner that the holding plate 26 dose not interfere with the loading and unloading of the ingot 11. In addition, after the ingot 11 is held on the holding surface of the holding table 20, the lifting/lowering mechanism is actuated such that the holding plate 26 is lowered, the holding surface of the holding plate 26 can be brought into contact with the ingot 11 (more specifically, its upper surface).

Moreover, each of the plurality of suction ports formed in the holding surface of the holding plate 26 can be communicated with a suction source (not illustrated) such as an ejector, through a fluid channel and the like formed in the holding plate 26. When the suction source communicating with the plurality of suction ports is actuated, it creates and transmits a suction force through the fluid channel and the porous plate to a space near the holding surface of the holding plate 26.

Accordingly, the ingot 11 (more specifically, its upper surface) held on the holding surface of the holding table 20 is brought into contact with the holding surface of the holding plate 26, and then, the suction source communicating with the plurality of suction ports is actuated, so that the holding table 20 and the holding plate 26 can hold the ingot 11 therebetween.

In addition, the support member 24 is coupled with a rotational mechanism, not depicted. This rotating mechanism includes, for example, a driven pulley coupled with the support member 24, a belt wound around the driven pulley, a drive pulley coupled with the driven pulley through the belt, and a motor for rotating the drive pulley.

When the rotating mechanism (more specifically, its motor) is actuated, with a straight line along the vertical direction passing through the center of the holding plate 26 as a rotational axis, the support member 24 and the holding plate 26 are rotated. Hence, the holding table 20 and the holding plate 26 hold the ingot 11 therebetween, and the rotating mechanism is then actuated, so that the orientation of the ingot 11 can be adjusted.

A nozzle 28 is provided obliquely above the holding table 20. This nozzle 28 is coupled with the lifting/lowering mechanism (not illustrated). In addition, the lifting/lowering mechanism includes a ball screw a nut of which is coupled with the nozzle 28, and a motor for rotating a screw axis of the ball screw.

Then, when the lifting/lowering mechanism (more specifically, its motor) is actuated, the nozzle 28 moves up and down. Hence, the holding table 20 and the holding plate 26 hold the ingot 11 therebetween, and the lifting/lowering mechanism is then actuated, the nozzle 28 can be positioned at a height corresponding to the height of the peel-off layer 15 formed in the ingot 11.

Moreover, the nozzle 28 can be communicated with, for example, an air supply source such as an air compressor (not illustrated). Then, when the air supply source communicating with the nozzle 28 is actuated, air A which is substantially perpendicular to the vertical direction and which goes to the center of the holding table 20 in plan view is ejected from the nozzle 28. Hence, after the nozzle 28 is positioned at the height corresponding to the height of the peel-off layer 15 formed in the ingot 11, the air supply source communicating with the nozzle 28 is actuated, so that the air A can be ejected toward a particular portion included in the outer periphery of the peel-off layer 15 of the ingot 11.

When the peeling apparatus 18 performs the peeling step S2, first, the distance between the holding table 20 and the holding plate 26 is made larger than the thickness of the ingot 11, and, for example, the ingot 11 is loaded onto the holding table 20 such that the front surface 11a thereof faces upward (see FIG. 10A). Subsequently, the back surface 11b side of the ingot 11 is held on the holding surface of the holding table 20. Then, the holding plate 26 is lowered until the holding surface thereof comes into contact with the front surface 11a of the ingot 11.

Subsequently, the front surface 11a side of the ingot 11 is held on the holding surface of the holding plate 26, in other words, the holding table 20 and the holding plate 26 hold the ingot 11 therebetween. Next, the nozzle 28 is moved up and down in such a manner as to be positioned at the height corresponding to the height of the peel-off layer 15 formed in the ingot 11. Then, while the holding table 20 and the holding plate 26 are rotated at the same orientation (specifically, in plan view, in a clockwise or counterclockwise orientation) and at the same peripheral speed, the air A is ejected from the nozzle 28 (see FIG. 10B).

Accordingly, an external force is applied to the entire region of the peel-off layer 15 of the ingot 11, and the cracks 15b further extend. As a result, with the peel-off layer 15 as the separation initiating point, the front surface 11a side of the ingot 11 (specifically, a substrate to be used for manufacture of dies of semiconductor devices) is peeled off from the back surface 11b side thereof, and the peeling step S2 is ended.

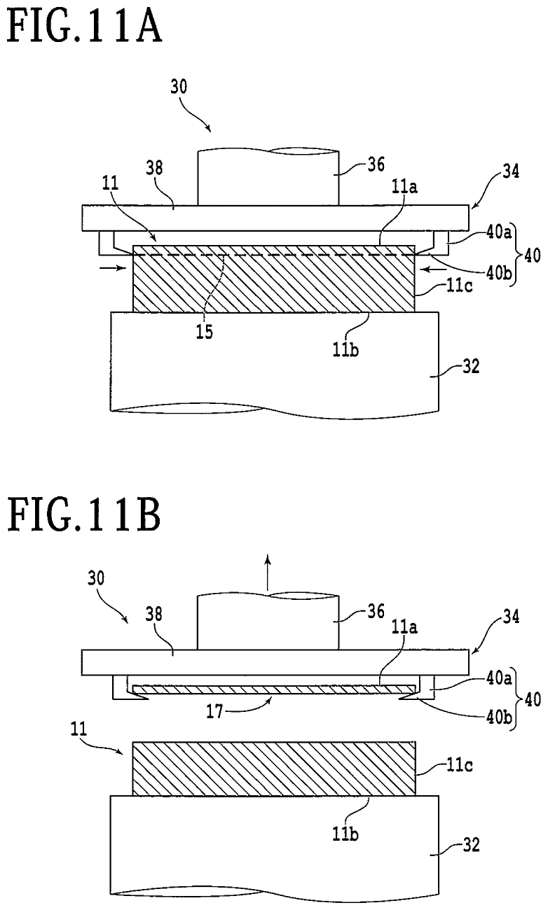

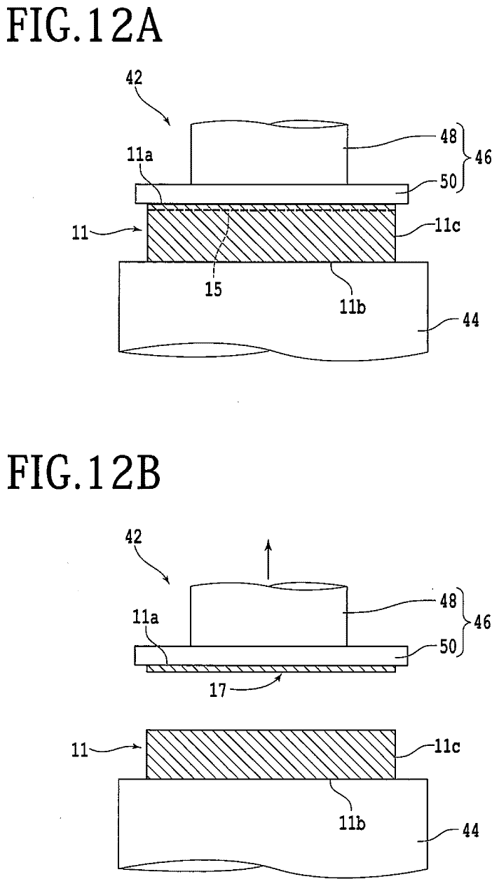

Note that, in the peeling step S2, in a peeling apparatus having a structure different from the peeling apparatus 18, the front surface 11a side of the ingot 11 may be peeled off from the back surface 11b side thereof. FIG. 11A and FIG. 11B as well as FIG. 12A and FIG. 12B each schematically illustrate in side elevation, partly in cross section, an example of the peeling step S2 to be performed in a peeling apparatus (peeling apparatuses 30 and 42) different from the peeling apparatus 18.

The peeling apparatus 30 illustrated in FIG. 11A and FIG. 11B has a holding table 32 for holding the ingot 11 in which the peel-off layer 15 is formed. Specifically, the holding table 32 has a circular upper surface (holding surface) which is perpendicular to the vertical direction and where an undepicted porous plate is exposed upwardly. Moreover, the porous plate is fluidly communicated with an undepicted suction source such as an ejector, for example, through an undepicted fluid channel, for example, defined in the holding table 32.

When the suction source communicating with the porous plate is actuated, it creates and transmits a suction force through the fluid channel and the porous plate to a space near the holding surface of the holding table 32. Hence, after the ingot 11 is placed on the holding surface of the holding table 32 and the suction source communicating with the porous plate is then actuated, the ingot 11 can be held on the holding surface of the holding table 32.

Provided above the holding table 32 is a wedge insertion unit 34. The wedge insertion unit 34 has a cylindrical support member 36. In addition, a lower end of the support member 36 is fixed to a center of an upper portion of a base 38 in a circular-plate shape. Then, below an outer peripheral region of the base 38, a plurality of movable members 40 are provided at substantially equal intervals along a peripheral direction of the base 38.

Each of the movable members 40 has a plate-like downwardly extending portion 40a which extends downward from a lower surface of the base 38. The downwardly extending portion 40a has a plate-like wedge portion 40b provided on an inner surface of a lower end thereof, and the wedge portion 40b extends toward the center of the base 38 and has a thickness being thinner toward its tip end.

In addition, the support member 36 is coupled with a lifting/lowering mechanism, not depicted. This lifting/lowering mechanism includes a ball screw a nut of which is coupled with the support member 36, and a motor for rotating a screw axis of the ball screw. Then, when the lifting/lowering mechanism (more specifically, its motor) is actuated, the support member 36, the base 38, and the plurality of movable members 40 move upward.

Thus, prior to loading of the ingot 11 onto the holding table 32 or unloading therefrom, the lifting/lowering mechanism is actuated in such a manner as to lift the plurality of movable members 40 and the like, so that the plurality of movable members 40 and the like can be sufficiently apart from the holding table 32 in such a manner as not to interfere with the loading and unloading of the ingot 11. In addition, the lifting/lowering mechanism is actuated such that the support member 36 and the like are lowered after the ingot 11 is held on the holding surface of the holding table 32, so that a tip end of the wedge portion 40b of each of the movable members 40 can be positioned at a height corresponding to the height of the peel-off layer 15 formed in the ingot 11.

Moreover, an upper end of the downwardly extending portion 40a of each of the movable members 40 is coupled with the actuator of the air cylinder or the like incorporated in the base 38, and this actuator is operated, so that the movable member 40 moves along a radial direction of the base 38. Accordingly, the tip end of the wedge portion 40b of each of the movable members 40 is positioned at the height corresponding to the height of the peel-off layer 15 formed in the ingot 11, and the actuator is then actuated, so that the plurality of wedge portions 40b can each be driven into each of a plurality of portions in the vicinity of the outer periphery of the peel-off layer 15.

In addition, the support member 36 is coupled with a rotational mechanism, not depicted. This rotating mechanism includes, for example, a driven pulley coupled with the support member 36, a belt wound around the driven pulley, a drive pulley coupled with the driven pulley through the belt, and a motor for rotating the drive pulley.

Then, the rotating mechanism (more specifically, its motor) is actuated, with the straight line along the vertical direction passing through the center of the base 38 as a rotational axis, the support member 36, the base 38, and the plurality of movable members 40 are rotated. Accordingly, the plurality of wedge portions 40b are each driven into each of the plurality of portions in the vicinity of the outer periphery of the peel-off layer 15, and the rotating mechanism is then actuated, each of the wedge portions 40b which is driven into the peel-off layer 15 can be rotated around the outer periphery of the peel-off layer 15 so as to follow the contour of the outer periphery thereof.

In the peeling apparatus 30, when the peeling step S2 is performed, first, the distance in the vertical direction between the holding table 32 and the plurality of movable members 40 is made larger than the thickness of the ingot 11, and in a state in which each of the plurality of movable members 40 is positioned outside of the radial direction of the base 38, for example, the ingot 11 is loaded onto the holding table 32 such that the front surface 11a of the ingot 11 faces upward.

Subsequently, the back surface 11b side of the ingot 11 is held on the holding surface of the holding table 32. Then, the movable members 40 and the like are lowered until the tip end of the wedge portion 40b of each of the movable members 40 is positioned at the height corresponding to the height of the peel-off layer 15 formed in the ingot 11. Subsequently, each of the plurality of wedge portions 40b is driven into each of the plurality of portions in the vicinity of the outer periphery of the peel-off layer 15 (see FIG. 11A).

Next, the plurality of wedge portions 40b are rotated circumferentially. Then, the plurality of wedge portions 40b are lifted (see FIG. 11B). Accordingly, an external force is applied to the entire region of the peel-off layer 15 of the ingot 11, and the cracks 15b further extend. As a result, with the peel-off layer 15 as the separation initiating point, the front surface 11a side of the ingot 11 (specifically, a substrate 17 to be used for manufacture of dies of the semiconductor devices) is peeled off from the back surface 11b side thereof, and the peeling step S2 is ended.

The peeling apparatus 42 illustrated in FIG. 12A and FIG. 12B has a suction table 44 for holding under suction the ingot 11 in which the peel-off layer 15 is formed. This suction table 44 has a circular upper surface (suction surface) perpendicular to the vertical direction, and a porous plate (not illustrated) is exposed in the suction surface. Moreover, the porous plate is fluidly communicated with an undepicted suction source such as a vacuum pump, for example, through an undepicted fluid channel, for example, defined in the suction table 44.

When the suction source communicating with the porous plate is actuated, it creates and transmits a suction force through the fluid channel and the porous plate to a space near the suction surface of the suction table 44. Accordingly, the ingot 11 is placed on the suction surface of the suction table 44 and the suction source communicating with the porous plate is actuated, the ingot 11 placed on the suction surface of the suction table 44 can be sucked so as to be pulled downward.

Provided above the suction table 44 is a suction unit 46. The suction unit 46 has a cylindrical support member 48. In addition, a lower end of the support member 48 is fixed to a center of an upper portion of the suction plate 50 in a circular-plate shape. This suction plate 50 has a circular lower surface (suction surface) perpendicular to the vertical direction, and this suction surface has a plurality of suction ports formed therein.

In addition, the support member 48 is coupled with a lifting/lowering mechanism, not depicted. This lifting/lowering mechanism includes a ball screw a nut of which is coupled with the support member 48, and a motor for rotating a screw axis of the ball screw. Then, when the lifting/lowering mechanism (more specifically, its motor) is actuated, the support member 48 moves up and down.

Accordingly, prior to loading of the ingot 11 onto the suction table 44 or unloading therefrom, the lifting/lowering mechanism is actuated such that the suction plate 50 moves upward, so that the suction plate 50 can sufficiently be apart from the suction table 44 in such a manner as not to interfere with the loading and unloading of the ingot 11. In addition, a suction force is applied to the ingot 11 from the suction surface of the suction table 44, and the lifting/lowering mechanism is then actuated such that the suction plate 50 is lowered, so that the suction surface of the suction plate 50 can be brought into contact with the ingot 11 (more specifically, its upper surface).

Moreover, each of the plurality of suction ports formed in the suction surface of the suction plate 50 can be communicated with a suction source (not illustrated) such as a vacuum pump, through a fluid channel, for example, formed in the suction plate 50. When the suction source communicated with the plurality of suction ports is actuated, a suction force acts in a space near the suction surface of the suction plate 50.

Accordingly, the suction surface of the suction plate 50 is brought into contact with the ingot 11 (more specifically, its upper surface) having a suction force from the suction surface of the suction table 44 applied thereto, and then, by actuating the suction source communicating with the plurality of suction ports, this ingot 11 can be sucked in such a manner as to be pulled upward.

When the peeling step S2 is performed in the peeling apparatus 42, first, in a state in which the distance between the suction table 44 and the suction plate 50 is made larger than the thickness of the ingot 11, for example, the ingot 11 is loaded onto the suction table 44 such that the front surface 11a thereof faces upward. Then, a suction force is applied to the back surface 11b side of the ingot 11 from the suction surface of the suction table 44. Subsequently, the suction plate 50 is lowered until the suction surface thereof comes into contact with the front surface 11a of the ingot 11 (see FIG. 12A).

Then, a suction force is applied to the front surface 11a side of the ingot 11 from the suction surface of the suction plate 50. Then, the suction plate 50 is lifted (see FIG. 12B). Accordingly, an external force is applied to the peel-off layer 15 toward the thickness direction of the ingot 11, and the cracks 15b further extend. As a result, with the peel-off layer 15 as the separation initiating point, the front surface 11a side of the ingot 11 (specifically, a substrate 17 to be used for manufacture of dies of the semiconductor devices) is peeled off from the back surface 11b side thereof, and the peeling step S2 is ended.

Moreover, in the peeling step S2, prior to separation of the front surface 11a side of the ingot 11 having the peel-off layer 15 as the separation initiating point from the back surface 11b side of the ingot 11, an ultrasonic wave may be applied to the front surface 11a side of the ingot 11. In this case, the cracks 15b included in the peel-off layer 15 further extend, so that the front surface 11a side of the ingot 11 can easily be peeled off from the back surface 11b side thereof. Alternatively, in the peeling step S2, an ultrasonic wave only is applied to the front surface 11a side of the ingot 11, and accordingly, the front surface 11a side may be peeled off from the back surface 11b side.

In the embodiment described above, in the peel-off layer forming step S1, the peel-off layer 15 is formed in the ingot 11 such that, when the ingot 11 is viewed in plan, the proportion of the modified portions which is the proportion of the area of the modified portions 15a to the area of the peel-off layer 15 is over 0% and equal to or less than 24%. Hence, in the peeling step S2, breakage of the substrate 17 occurring when part of the ingot 11 which is to be the substrate 17 with the peel-off layer 15 as the separation initiating point is peeled off from the rest thereof can be prevented.

Note that, in the embodiment described above, a workpiece to be used for manufacturing the substrate 17 is not limited to the ingot 11 illustrated in FIG. 1, FIG. 2, and other figures. This workpiece may be, for example, a single-crystal silicon whose crystal plane not included in the crystal planes {100} is exposed in each of the front surface and the back surface. In addition, this workpiece may be an ingot in which a notch is formed in its side surface or an ingot in which either orientation flat or notch is not formed in its side surface.

In addition, the workpiece may be, for example, a bare wafer having a thickness of not less than twice and not more than five times that of the substrate 17 to be manufactured. Note that this bare wafer is manufactured by being separated from the ingot 11, for example, in the same method as that described above. In this case, the substrate 17 can be expressed as being manufactured by repeating the above method twice as well.

In addition, the workpiece may be a device wafer to be manufactured by forming semiconductor devices on one side of the bare wafer. In this case, the laser beam LB may preferably be applied to the device wafer from the other surface side of the device wafer (a side on which the semiconductor devices are not formed) in order to prevent adverse effects on the semiconductor devices.

In addition, the material of the workpiece is not limited to a single-crystal silicon. This material may be, for example, a single crystal made of silicon carbide, gallium nitride, gallium oxide, lithium tantalate (LT), or lithium niobate (LN).

### Working Example 1

Under different irradiation conditions, 12 workpieces each having single-crystal silicon as a material were irradiated with laser beams, thereby forming a peel-off layer in each of the workpieces. Note that the procedure when the peel-off layer is formed is the same as that indicated in FIG. 7. Then, the proportion of the modified portions of the peel-off layer formed in each of the workpieces was studied, and a processing quality when part of the workpiece was peeled off from the rest thereof with the peel-off layer as the separation initiating point was evaluated.

Table 1 indicates the irradiation conditions of the laser beams set for 12 workpieces (workpieces W1 to W12).

TABLE 1

| | | | Depth | | | |
|---|---|---|---|---|---|---|
| | | | of | | | |
| | Output | | focused | Number | Processing | Index |
| | power | Frequency | spot | of | feed speed | amount |
| Workpiece | (W) | (Hz) | (μm) | splits | (mm/s) | (μm) |
| W1 | 6.4 | 40 | 900 | 16 | 270 | 290 |
| W2 | 6.4 | 40 | 900 | 16 | 270 | 320 |
| W3 | 6.4 | 40 | 900 | 16 | 270 | 320 |
| W4 | 6.4 | 40 | 1250 | 16 | 270 | 360 |
| W5 | 6.4 | 40 | 900 | 16 | 270 | 460 |
| W6 | 6.4 | 40 | 900 | 16 | 270 | 480 |
| W7 | 6.4 | 120 | 900 | 4 | 810 | 100 |
| W8 | 5.6 | 80 | 900 | 7 | 540 | 290 |
| W9 | 6 | 120 | 1200 | 5 | 810 | 200 |
| W10 | 3.6 | 120 | 900 | 3 | 810 | 100 |
| W11 | 6.4 | 160 | 900 | 4 | 1080 | 170 |
| W12 | 6 | 120 | 900 | 5 | 810 | 230 |

Note that the irradiation conditions of the laser beams for the workpieces W1 to W6 and W8 to W12 are set such that the pulsed energies of the split laser beams are equal to each other. More specifically, in these irradiation conditions, the output power of each of the split laser beams, specifically, the output power obtained by dividing “output power (W)” by “frequency (Hz)” and “the number of splits” is set to 0.01 mJ. In addition, the irradiation condition of the laser beam for the workpiece W7 is set such that the pulsed energies of the split laser beams are 0.0133 mJ.

In addition, the irradiation conditions of the laser beams for the workpieces W1 to W12 are set such that irradiation pitches of the split laser beams are equal to each other. More specifically, in these irradiation conditions, the irradiation pitch of each of the split laser beams, specifically, a distance obtained by dividing “processing feed speed (mm/s)” with “frequency (Hz)” is set to 6.75 μm.

Table 2 indicates the proportion of the modified portions in the peel-off layer formed in each of the workpieces W1 to W12 due to the irradiation of the laser beam according to the irradiation condition indicated in Table 1, and the processing quality when part of each of the workpieces W1 to W12 is peeled off from the rest thereof with each of the peel-off layers as the separation initiating point.

TABLE 2

| | Proportion of modified | Processing |
|---|---|---|
| Workpiece | portions (%) | quality |
| W1 | 41 | Poor |
| W2 | 38 | Poor |
| W3 | 38 | Poor |
| W4 | 33 | Poor |
| W5 | 26 | Poor |
| W6 | 25 | Poor |
| W7 | 24 | Fair |
| W8 | 17 | Fair |
| W9 | 16 | Good |
| W10 | 16 | Good |
| W11 | 14 | Good |
| W12 | 14 | Good |

Note that, in Table 2, “Poor,” “Fair,” and “Good” indicated in the filed “processing quality,” respectively, mean that, in the part of each of the workpieces W1 to W12 peeled off from the rest thereof, breakage severe enough to prevent formation of the semiconductor devices is recognized, that, while formation of the semiconductor devices is possible, breakage is recognized, and that formation of the semiconductor devices is possible and noticeable breakage cannot be recognized.

As indicated in Table 2, a correlation between the proportion of the modified portions of the peel-off layer formed in each of the workpieces W1 to W12 and the processing quality when the part of each of the workpieces W1 to W12 is peeled off from the rest thereof with the peel-off layer as the separation initiating point has been found out. More specifically, in a case in which the proportion of the modified portions is over 0% and equal to or less than 24%, it has been found out that, when the part of each of the workpieces W1 to W12 is peeled off from the rest thereof with the peel-off layer as the separation initiating point, breakage in the relevant part can be prevented. Moreover, in a case in which the proportion of the modified portions is over 0% and equal to or less than 16%, it has been found out that, when the part of each of the workpieces W1 to W12 is peeled off from the rest thereof with the peel-off layer as the separation initiating point, breakage of the relevant part can further be prevented.

### Working Example 2

The peel-off layers are formed in three workpieces made of single-crystal silicon as a material at different proportions of the peel-off layers. Then, the proportion of the peel-off layer formed in each of the workpieces was studied, and a processing quality when part of the workpiece is peeled off from the rest thereof with the peel-off layer as the separation initiating point was evaluated.

Table 3 indicates the proportions of the peel-off layers in the three workpieces (workpieces W13 to W15) and the processing qualities when the part of each of the workpieces W13 to W15 is peeled off from the rest thereof with each of the peel-off layers as the separation initiating point.

TABLE 3

| | Proportion of peel- | Processing |
|---|---|---|
| workpiece | off layer (%) | quality |
| W13 | 95 | Poor |
| W14 | 98 | Good |
| W15 | 99 | Good |

Note that, in Table 3, “Poor” and “Good” indicated in the field “processing quality,” respectively, mean that, in the part of each of the workpieces W13 to W15 peeled off from the rest thereof, breakage severe enough to prevent formation of the semiconductor devices has been recognized, and that, while formation of the semiconductor devices is possible, noticeable breakage has not been recognized.

As indicated in Table 3, a correlation between the proportion of the peel-off layer of each of the workpieces W13 to W15 and the processing quality when the part of each of the workpieces W13 to W15 is peeled off from the rest thereof with the peel-off layer as the separation initiating point has been found out. More specifically, it has been found out that, in a case in which the proportion of the peel-off layer of each of the workpieces W13 to W15 is equal to or more than 98%, when the part of each of the workpieces W13 to W15 is peeled off from the rest thereof with the peel-off layer as the separation initiating point, the breakage of the relevant part can be prevented.

The structural and methodical details and features according to the above embodiments can be changed or modified without departing from the scope of the invention.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A substrate manufacturing method of manufacturing, from a workpiece, a substrate having a thickness smaller than that of the workpiece, the method comprising:
moving a focused spot and the workpiece relative to each other, while irradiating the workpiece with a laser beam having a wavelength transmissible through a material of the workpiece in such a manner that the focused spot is positioned inside the workpiece, thereby forming a peel-off layer including modified portions and cracks extending from the modified portions in the workpiece; and
peeling off part of the workpiece which is to be the substrate from the rest thereof, with the peel-off layer as a separation initiating point,
wherein an irradiation condition of the laser beam is set such that, when the workpiece is viewed in plan, the peel-off layer having a proportion of the modified portions that is a proportion of an area of the modified portions to an area of the peel-off layer is over 0% and equal to or less than 24% is formed.

2. The substrate manufacturing method according to claim 1,
wherein the irradiation condition is set such that the peel-off layer is formed such that the proportion of the modified portions is equal to or less than 16%.

3. The substrate manufacturing method according to claim 1,
wherein the peeling-off of the part of the workpiece from the rest thereof is performed after, when the workpiece is viewed in plan, a proportion of the peel-off layer that is a proportion of the area of the peel-off layer to the area of the workpiece is 98% or more.

4. The substrate manufacturing method according to claim 1,
wherein the material of the workpiece is a single crystal made of silicon.

5. A laser processing method of using a laser beam having a wavelength transmissible through a material of a workpiece and forming a peel-off layer including modified portions and cracks extending from the modified portions, in the workpiece, the method comprising:
moving a focused spot and the workpiece relative to each other, while irradiating the workpiece with the laser beam in such a manner that the focused spot is positioned inside the workpiece, thereby forming the peel-off layer having a proportion of the modified portions that is a proportion of an area of the modified portions to an area of the peel-off layer is over 0% and equal to or less than 24% when the workpiece is viewed in plan.
